(19) United States
(12) Patent Application Publication
(10) Pub. No.: US 2017/0314732 A1
(43) Pub. Date: Nov. 2, 2017

(54) APPARATUSES THAT PROVIDE A MOUNT AND A STAND FOR PORTABLE ELECTRONIC DEVICES

(71) Applicant: Kenu, Inc., San Francisco, CA (US)

(72) Inventors: Kenneth Y. Minn, San Francisco, CA (US); David E. Yao, San Francisco, CA (US); Leonard John Duran, Mill Valley, CA (US)

(73) Assignee: Kenu, Inc., San Francisco, CA (US)

(21) Appl. No.: 15/185,606

(22) Filed: Jun. 17, 2016

Related U.S. Application Data
(63) Continuation-in-part of application No. 15/139,741, filed on Apr. 27, 2016.

(51) Int. Cl. F16M 13/02; F16M 11/06; F16B 2/22; F16B 2/04; B60R 11/02; B60R 7/04; H04M 1/04; A47B 23/04; B60R 11/00

(52) U.S. Cl. CPC F16M 13/022; H04M 1/04; F16M 11/06; F16B 2/22; A47B 23/04; F16B 2/04; B60R 11/0252; B60R 7/043; B60R 2011/0017

(57) ABSTRACT

An apparatus for mounting a portable electronic device to a pair of spaced apart posts (e.g., of a vehicle headrest or a suitcase), is also useful as a stand to support a portable electronic device at an angle relative to a horizontal support surface on which the apparatus rests. The apparatus includes a first element configured to be selectively attached to a pair of spaced apart posts by application of an external compressive or expansive force to thereby decrease or increase a distance between portions of the first element until grips of the first element can be aligned with and attached to the spaced apart posts, and then removing the external compressive or expansive force. The apparatus also includes a second element that is attached to the first element and is configured to selectively hold a portable electronic device. The apparatus, when used as a stand, functions like a tripod.

### PRIORITY CLAIM

This application is a continuation-in-part (CIP) of U.S. patent application Ser. No. 15/139,741, filed Apr. 27, 2016, which is incorporated herein by reference.

### FIELD OF TECHNOLOGY

Embodiments of the present technology generally relate to apparatuses that can be used for mounting portable electronic devices, such as tablets, e-book readers, or smart phones, to spaced apart posts (e.g., of vehicle headrests). Such apparatuses can also be used as a stand for the portable electronic devices.

### BACKGROUND

Portable electronic devices, such as tablets (also known as tablet computers), e-book readers, and smart phones, are becoming increasingly popular and are now routinely carried to provide entertainment while traveling in a vehicle.

Conventionally, vehicle integrated entertainment systems, such as rear seat entertainment systems, have been mounted inside back portions of vehicle headrests. However, this required expensive custom modifications of existing headrests, or expensive replacement headrests that were specifically manufactured to include a video monitor, a DVD player and/or a satellite television receiver. Further, such systems are typically difficult and expensive to repair and/or upgrade. Additionally, such systems are typically limited to playing DVDs and/or satellite television, and thus, do not provide the functionality and content that tablets and smart phones provide, to which people have become accustomed. Because of this, there has been an increasing desire to mount portable electronic devices, which people already own, within vehicles, so as to avoid having to purchase expensive replacement headrests or having to modify existing headrests, and so as to provide the functionality and content to which people have become accustomed.

In an attempt to fulfill this desire, numerous attachment apparatuses, also known as mounting apparatuses, have been offered that attach portable electronic devices to headrest posts of vehicles. While these attachment apparatuses heretofore may meet at least some of their respective objectives and requirements, they typically have various drawbacks. Exemplary drawbacks include interfering with the operation of the headrest and an unattractive appearance. A further drawback is that such apparatuses may only be useful with headrests having a very specific spacing between the pair of headrest posts. Further, while some such apparatuses may be adjustable to accommodate a range of distances between headrest posts, the adjustment mechanisms have typically been cumbersome and/or complex, which often makes such attachment apparatuses difficult to use and expensive to manufacture. Additionally, many such attachment apparatuses require a headrest to be temporarily removed from a seat in order for the attachment apparatuses to be installed.

### SUMMARY

Apparatuses that are useful for mounting portable electronic devices in vehicles are described herein. In accordance with certain embodiments, an apparatus for use in mounting a portable electronic device in a vehicle, which is also referred to as a mounting apparatus, includes an element that is compressible or expandable, first and second grips, and a device holder. The element that is compressible or expandable has first and second ends that are spaced apart from one another by a first distance when the element is in its uncompressed or unexpanded state. The first and second ends of the element are movable towards or away from one another by application of an external force that causes the first and second ends of the element to be spaced apart from one another by less than or more than the first distance. The element is biased to try to return to its uncompressed or unexpanded state when the external force is not being applied. The first and second grips extend, respectively, from the first and second ends of the element, and are configured to grip a pair of spaced apart vehicle headrest posts. The device holder, which is attached to a portion of the element between the first and second ends, is configured to selectively hold a portable electronic device.

In accordance with certain embodiments, the element (that is compressible or expandable) comprises a compressible element, and the first and second ends of the compressible element are movable towards one another by application of an external compressive force that causes the first and second ends of the compressible element to be spaced apart from one another by less than the first distance. The compressible element is biased to try to return to its uncompressed state when the external compressive force is not being applied. In such embodiments, the apparatus is configured to be selectively attached to a pair of spaced apart vehicle headrest posts, without removing a vehicle headrest from a seatback to which the vehicle headrest is attached by the posts, by applying a compressive force to the compressible element until the first and second ends of the compressible element are spaced apart from one another by a distance that is less than an inter-post distance between the spaced apart vehicle headrest posts to which the apparatus is to be attached, inserting the first and second ends of the compressible element between the spaced apart vehicle headrest posts, aligning the first and second grips with the spaced apart posts of the vehicle headrest, and removing the compressive force to thereby allow the compressible element to become at least partially uncompressed and the first and second grips to grip the spaced apart vehicle headrest posts.

In accordance with other embodiments, the element (that is compressible or expandable) comprises an expandable element, and the first and second ends of the expandable element are movable away from one another by application of an external expansive force that causes the first and second ends of the expandable element to be spaced apart from one another by more than the first distance. The expandable element is biased to try to return to its unexpanded state when the external expansive force is not being applied. In such embodiments, the apparatus is configured to be selectively attached to a pair of spaced apart vehicle headrest posts, without removing a vehicle headrest from a seatback to which the vehicle headrest is attached by the posts, by applying an expansive force to the expandable element until the first and second ends of the expandable element are spaced apart from one another by a distance that is greater than an inter-post distance between the spaced apart vehicle headrest posts to which the apparatus is to be attached, aligning the first and second grips with the spaced apart posts of the vehicle headrest, and removing the expansive force to thereby allow the expandable element to become at least partially unexpanded and the first and second grips to grip the spaced apart vehicle headrest posts.

In accordance with certain embodiments, the element that is compressible or expandable comprises a curved band of a flexible material having shape-memory. The flexible material having shape-memory can comprise at least one of a plastic material, a carbon fiber material, a fiber glass material, a glass filled plastic material, a metal or an alloy, or a combination thereof. The element that is compressible or expandable, which is made of a flexible material having shape-memory, can have any one of a plurality of different shapes, such as, but not limited to, a U-shape, a C-shape, a V-shape, a sinusoidal shape, a partial sinusoidal shape, a partial circular shape, or a partial elliptical shape.

In accordance with certain embodiments, the element that is compressible or expandable comprises a linearly compressible element including one or more springs that is/are linearly compressible and is/are biased to try to return the linearly compressible element to its uncompressed state when an external compressive force is not being applied. In accordance with alternative embodiments, the element that is compressible or expandable comprises a linearly expandable element including one or more springs that is/are linearly expandable and is/are biased to try to return the linearly expandable element to its unexpanded state when an external expansive force is not being applied.

In accordance with certain embodiments, the device holder is attached to the portion of the element (that is compressible or expandable) between the first and second ends by a movable joint. The movable joint can comprise, e.g., a ball-and-socket joint or a partial ball-and-socket joint, but is not limited thereto.

In accordance with certain embodiments, the device holder comprises an adjustable clamp configured to secure a portable electronic device having any one of a plurality of different sizes between a pair of opposing arms of the adjustable clamp.

In accordance with certain embodiments, each of the first and second grips is configured to engage vehicle headrest posts having any one of a plurality of different diameters, e.g., within the range of 8 mm to 20 mm.

In accordance with certain embodiments, the first and second grips are attached to the element (that is compressible or expandable) by flexible hinges that cause the grips to rotate and counteract an external pushing or pulling force that is applied to the element.

An apparatus for mounting a portable electronic device in a vehicle, according to specific embodiments of the present technology, includes a flexible curved band having shape-memory, first and second grips attached to distal ends of the flexible curved band and configured to grip a pair of vehicle headrest posts, and a device holder attached to a portion of the flexible curved band between the distal ends. The apparatus can be configured to be selectively attached to a pair of spaced apart vehicle headrest posts, without removing a vehicle headrest from a seatback to which the vehicle headrest is attached by the posts, by applying a compressive force to the distal ends of the flexible curved band, inserting the distal ends of the flexible curved band between the spaced apart vehicle headrest posts, aligning the first and second grips with the spaced apart posts of the vehicle headrest, and removing the compressive force to thereby allow the flexible curved band to become at least partially uncompressed and the first and second grips to grip the spaced apart vehicle headrest posts. Alternatively, the apparatus can be configured to be selectively attached to a pair of spaced apart vehicle headrest posts, without removing a vehicle headrest from a seatback to which the vehicle headrest is attached by the posts, by applying an expansive force to the distal ends of the flexible curved band, aligning the first and second grips with the spaced apart posts of the vehicle headrest, and removing the expansive force to thereby allow the flexible curved band to become at least partially unexpanded and the first and second grips to grip the spaced apart vehicle headrest posts. In certain embodiments, the device holder is attached to the portion of the flexible curved band between the distal ends by a movable joint. Such a movable joint may be configured to enable the device holder to move relative to the flexible curved band with at least two degrees of freedom. The curve band may have, e.g., a partial circular shape, a partial elliptical shape, a sinusoidal shape or a partial sinusoidal shape. In certain embodiments, the first and second grips are attached to the flexible curved band by flexible hinges that cause the grips to rotate and counteract an external pushing or pulling force that is applied to the flexible curved band.

An apparatus for mounting a portable electronic device in a vehicle, according to specific embodiments of the present technology, comprises headrest attachment element and a device holder attached to the headrest attachment element. The device holder, which can comprise an adjustable clamp that is configured to selectively hold a portable electronic device having any one of a plurality of different sizes, can be attached to the headrest attachment element by a movable joint having at least three degrees of freedom, or potentially less degrees of freedom. The headrest attachment element, which includes a portion that is compressible or expandable, is configured to be attached to a pair of spaced apart vehicle headrest posts having any one of a plurality of different inter-post distances within a range of 90 mm-160 mm by application of an external compressive or expansive force to distal ends of the portion that is compressible or expandable to thereby decrease or increase a distance between the distal ends until grips of the headrest attachment element are aligned with and attached to the spaced apart vehicle headrest posts, and then removing the external compressive or expansive force. The portion of the headrest attachment element that is compressible or expandable is configured to remain partially compressed or partially expanded while the headrest attachment element is attached to vehicle headrest posts. In accordance with certain embodiments, the grips of the headrest attachment element that are to be aligned with and attached to vehicle headrest posts are attachable to vehicle headrest posts having any one of a plurality of different diameters within a range of 8 mm-20 mm. In accordance with certain embodiments, the portion of the headrest attachment element that is compressible or expandable is made of a plastic material, a carbon fiber material, a fiber glass material, a glass filled plastic material, a metal or alloy, or a combination thereof.

In accordance with certain embodiments, the portion of the headrest attachment element that is compressible or expandable has shape-memory and is configured to return to its uncompressed or unexpanded shape after an external compressive or expansive force is completely removed. In some such embodiments, the portion of the headrest attachment element that is compressible or expandable is configured to remain partially compressed or partially expanded while the headrest attachment element is attached to vehicle headrest posts due to the vehicle headrest posts preventing the portion of the headrest attachment element that is compressible or expandable from completely returning to its uncompressed or unexpanded state.

The apparatuses described herein can also be used outside of vehicles. For example, the apparatuses described herein can be used to attach a portable electronic device to a pair of spaced apart posts of a telescopic handle of a rolling suitcase, instead of to spaced apart vehicle headrest posts. In accordance with certain embodiments, such an apparatus comprises a first element including a portion that is compressible or expandable, and a second element attached to the first element, wherein the second element is configured to selectively hold a portable electronic device. In accordance with specific embodiments, the first element is configured to be selectively attached to a pair of spaced apart posts by application of an external compressive or expansive force to the portion that is compressible or expandable to thereby decrease or increase a distance between distal ends of the first element until grips of the first element can be aligned with and attached to the spaced apart posts, and then removing the external compressive or expansive force. The portion of the first element that is compressible or expandable is configured to remain partially compressed or partially expanded while the first element is attached by the grips to a pair of spaced apart posts.

In accordance with specific embodiments, the first and second elements are attached to one another by a movable joint that enables the first and second elements to be rotated relative to one another. When one of the first and second elements is rotated relative to the other such that the first and second elements are perpendicular to one another, the apparatus can be used as a stand that supports a portable electronic device, being held by the second element, at an acute angle relative to a horizontal surface (e.g., a tabletop) upon which the apparatus is resting. In accordance with certain embodiments, when the apparatus is used as a stand that supports a portable electronic device, the stand comprises three support legs. When the first and second elements are perpendicular to one another, the three support legs include, e.g., a first support leg comprising a first half of the first element, a second support leg comprising a second half of the first element, and a third support leg comprising a half of the second element. When such an apparatus is used as a stand, a portion of each of the three support legs rests on a horizontal surface, such that the apparatus functions like a tripod. The apparatus can also be used as a stand when the first and second elements are arranged such that they are parallel to one another. In such an arrangement, first and second halves of the first element (that includes a portion that is compressible or expandable) provide first and second support legs for resting on a horizontal surface, and a peripheral edge of a portable electronic device (held within the second element that is configured to selectively hold a portable electronic device) provides a third support for resting on the horizontal surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a front perspective view of an apparatus for mounting a portable electronic device in a vehicle, according to an embodiment of the present technology.

FIG. 2 is a rear perspective view of the mounting apparatus introduced in FIG. 1.

FIG. 3 is a front perspective view of the mounting apparatus introduced in FIG. 1, mounted to a pair of vehicle headrest posts and holding a portable electronic device.

FIG. 4 is a top view of the mounting apparatus introduced in FIG. 1 mounted to a pair of vehicle headrest posts.

FIG. 5 is a top view of the mounting apparatus introduced in FIG. 1, which is used to show how ends of a compressible element of the apparatus can be moved towards one another to enable the apparatus to be mounted to a pair of vehicle headrest posts without removing a replacing the posts.

FIG. 6 is a side view of the mounting apparatus introduced in FIG. 1, mounted to a pair of vehicle headrest posts and holding a portable electronic device, which view is used to show how a movable joint of the apparatus enables the portable electronic device to be maneuvered with various degrees of freedom.

FIG. 7 is a top view of an apparatus for mounting a portable electronic device in a vehicle, according to another embodiment of the present technology.

FIG. 8 is a top view of an apparatus for mounting a portable electronic device in a vehicle, according to still another embodiment of the present technology.

FIGS. 9A, 9B and 9C show alternative configurations for grips of a headrest attachment element of an apparatus for mounting a portable electronic device in a vehicle.

FIG. 10 shows an alternative embodiment of a headrest attachment element of an apparatus for mounting a portable electronic device in a vehicle.

FIGS. 11A and 11B, which are tops view of a headrest attachment element of an apparatus for mounting a portable electronic device in a vehicle, show how flexible joints can enable the grips of the headrest attachment element to rotate and counteract external forces that may be applied to the headrest attachment element.

FIG. 12 is a top view of a headrest attachment element of an apparatus for mounting a portable electronic device in a vehicle, according to an alternative embodiment of the present technology.

FIG. 13 is a top view of a headrest attachment element of an apparatus for mounting a portable electronic device in a vehicle, according to a further embodiment of the present technology.

FIG. 14 is a top view of a headrest attachment element of an apparatus for mounting a portable electronic device in a vehicle, according to still another embodiment of the present technology.

FIG. 15 illustrates how the apparatuses described herein can also be used to mount a portable electronic device to posts of a telescopic handle of a suitcase, instead of to vehicle headrest posts.

FIG. 16 illustrates how apparatuses described herein can be used as a tripod like stand for supporting a portable electronic device at an angle on a flat surface such as a tabletop.

### DETAILED DESCRIPTION

The benefits, features, and advantages of the various embodiments of the present technology will become better understood with regard to the following description, and accompanying drawings. The following description is presented to enable one of ordinary skill in the art to make and use embodiments of the present technology as provided within the context of a particular application and its requirements. Various modifications to the embodiments described herein will, however, be apparent to one skilled in the art, and the general principles defined herein may be applied to other embodiments. Therefore, the embodiments of the present invention are not intended to be limited to the particular embodiments shown and described herein, but are to be accorded the widest scope consistent with the principles and novel features herein disclosed.

In the description that follows, like numerals or reference designators will be used to refer to like parts or elements throughout. In addition, the first digit of a three digit reference number, or the first two digits of a four digit reference number, typically identifies the drawing in which the reference number first appears.

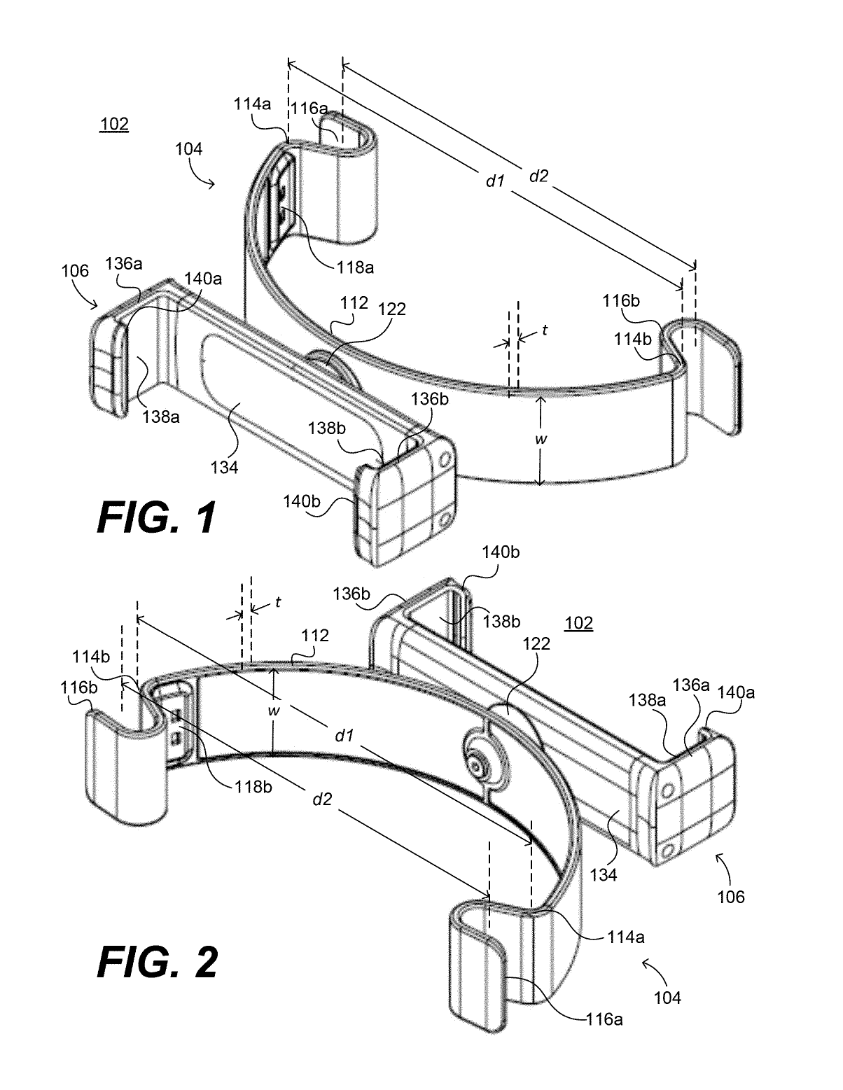

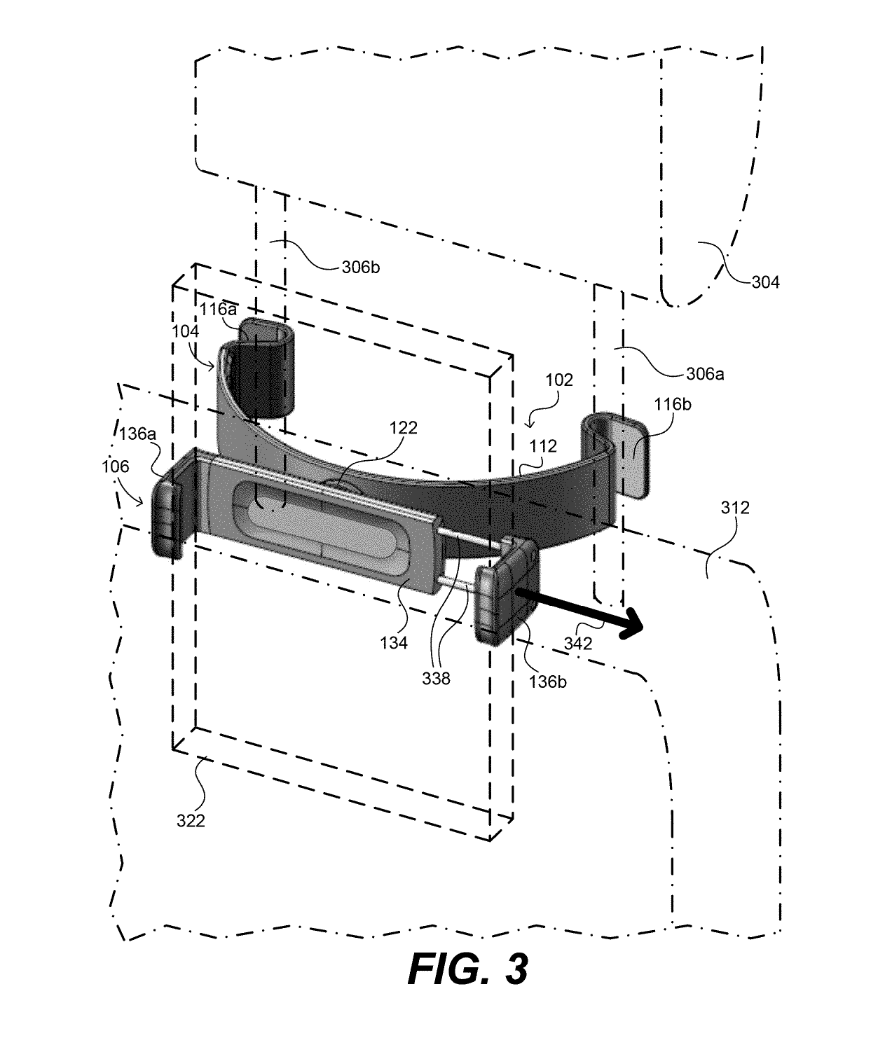

FIG. 1 is a front perspective view of an apparatus 102 for mounting a portable electronic device in a vehicle, according to an embodiment of the present technology, wherein the apparatus 102 can also be referred to as a mounting apparatus 102. FIG. 2 is a rear perspective view of the mounting apparatus 102 introduced in FIG. 1. Referring to FIGS. 1 and 2, the mounting apparatus 102 is shown as including a headrest attachment element 104 and a device holder element 106. The headrest attachment element 104 is configured to attach the mounting apparatus 102 to a vehicle headrest, and more specifically, to a pair of spaced apart vehicle headrest posts, as will be explained in more detail below with reference to FIGS. 3-6. The device holder element 106, which can also be referred to more succinctly as the device holder 106, is configured to selectively hold a portable electronic device, such as, but not limited to, a tablet, an e-book reader, or a smart phone.

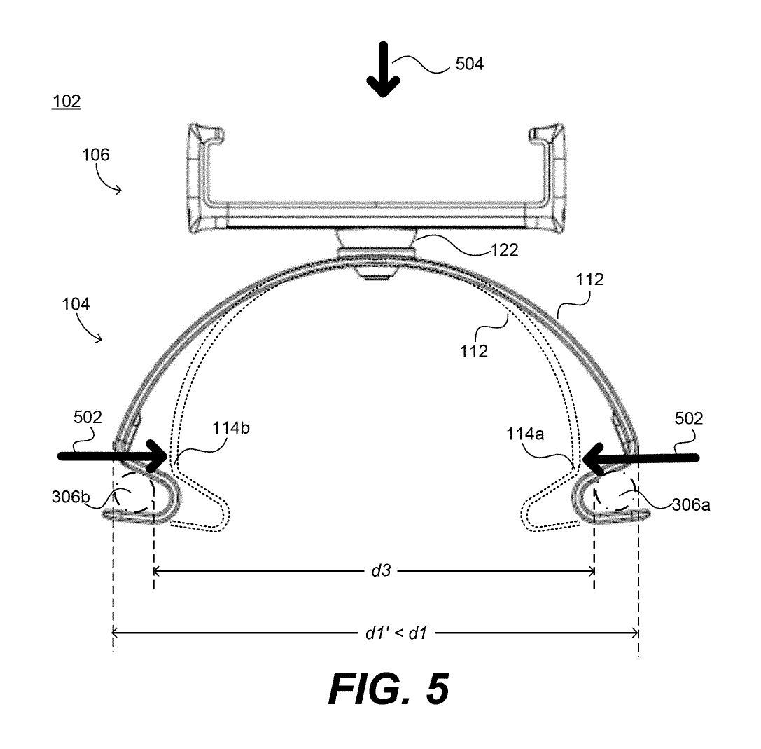

Still referring to FIGS. 1 and 2, the headrest attachment element 104 includes a compressible element 112 having first and second ends 114a, 114b that are spaced apart from one another by a distance (d1) when the compressible element 112 is in its uncompressed state. Briefly referring to FIG. 5, which is a top view of the mounting apparatus 102 introduced in FIG. 1, the first and second ends 114a, 114b of the compressible element 112 can be moved towards one another by applying a compressive force (e.g., applied by a person's hand(s)) represented by the arrows 502. More specifically, applying a compressive force, which can also be referred to as a compression force, causes the first and second ends 114a, 114b of the compressible element 112 to be spaced apart from one another by less than the distance (dl).

In FIG. 5, the compressible element 112 represented in solid line corresponds to the compressible element 112 in a partially compressed state, and the compressible element 112 represented in dotted line corresponds to the compressible element 112 in a more compressed state. The compressible element 112 is biased to return to its uncompressed state, when the compression force, represented by the arrows 502, is removed or otherwise not applied. However, the compressible element 112 will remain partially compressed if the spaced apart vehicle headrest posts (e.g., 306) prevent the compressible element 112 from completely returning to its uncompressed state. Accordingly, it can be said that the compressible element 112 is biased to try to return to its uncompressed state. As will be described in additional detail below, the compressible element 112 can be made of a material that has shape-memory, so that the compressible element 112 is biased so as to try to return to its uncompressed state. In FIG. 5, as well as in other FIGS., a distance denoted as being a “prime” distance (e.g., d1′, which is to be read “d1 prime”) indicates that the distance corresponds to when the compressible element is at least partially compressed. Accordingly, a non-prime distance will be greater than a prime distance (e.g., d1>d1′; and d2>d2′).

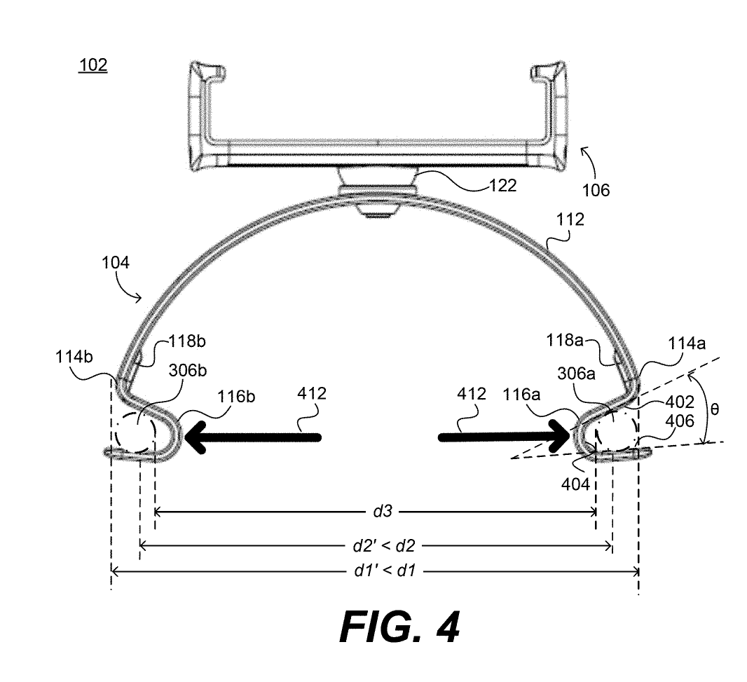

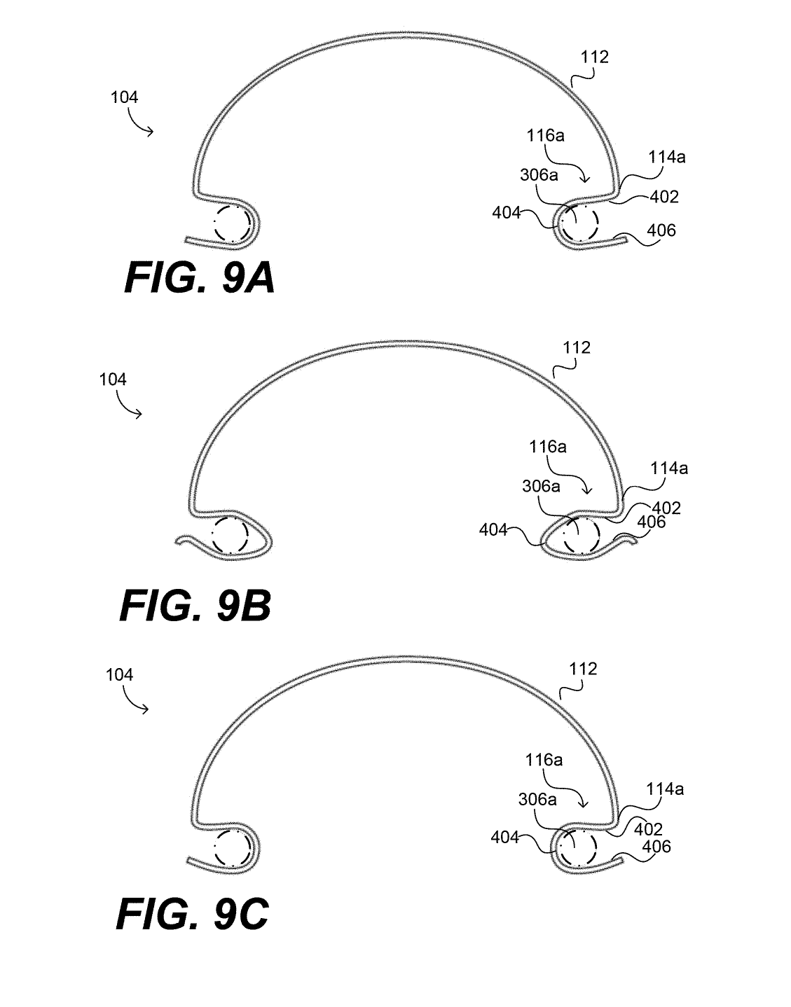

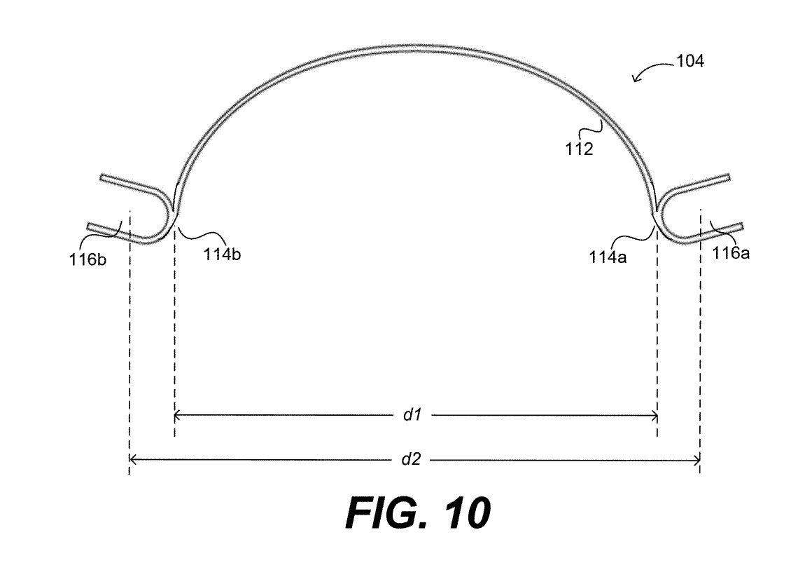

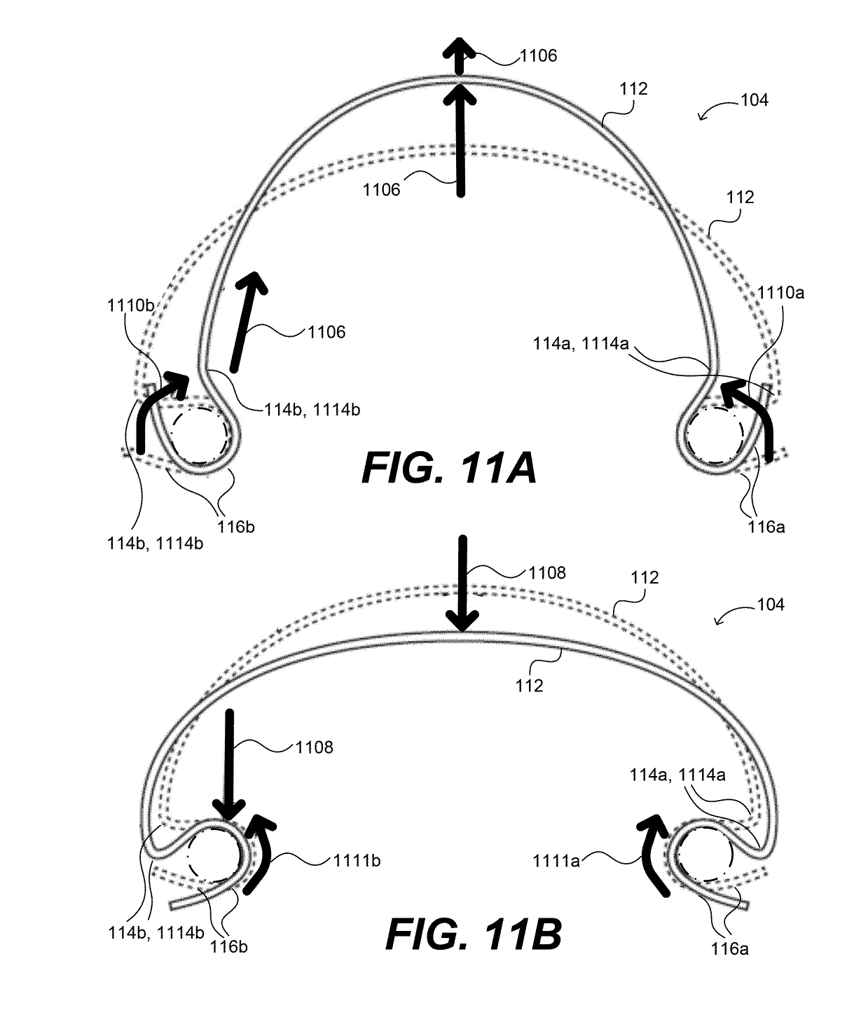

Referring again to FIGS. 1 and 2, the headrest attachment element 104 is also shown as including first and second post grip elements 116a, 116b, extending, respectively, from the first and second ends 114a, 114b of the compressible element 112. The post grip elements 116a, 116b can also be referred to more succinctly as grips 116a, 116b, collectively as grips 116 (or grip elements 116), or individually as a grip 116 (or a grip element 116). The first and second grips 116a, 116b are configured to grip a pair of spaced apart vehicle headrest posts (e.g., 306a, 306b in FIG. 3). The first grip 116a and the first end 114a of the compressible element 112 can be connected to one another by a first bracket 118a, as shown in FIG. 1. Similarly, the second grip 116b and the second end 114b of the compressible element 112 can be connected to one another by a second bracket 118b, as shown in FIG. 2. Alternatively, the first and second grips 116a, 116b can be integrally formed with the compressible element 112. In certain embodiments, examples of which are described below with reference to FIGS. 11A and 11B, the grips 116 can be connected to the compressible element 112 by flexible joints (e.g., living hinges), which may or may not be integrally formed with the compressible element 112. Additional details of the grips 116, according to certain embodiments of the present technology, are described below with reference to FIG. 4. Details of the grips 116, according to alternative embodiments of the present technology, are described below with reference to FIGS. 9A, 9B and 9C. In the embodiments show in FIGS. 1-8, a distance (d2) between centers of the first and second grips 116a and 116b is less than the distance (d1) between the first and second ends 114a and 114b of the compressible element. In alternative embodiments, such as the embodiment shown in FIG. 10, a distance (d2) between centers of the first and second grips 116a and 116b is greater than the distance (d1) between the first and second ends 114a and 114b of the compressible element.

In accordance with certain embodiments of the present technology, such as those shown in and discussed with reference to FIGS. 1-6, the compressible element 112 is implemented as a curved band of a flexible material. The flexible material of which the curved band is made can be, e.g., a plastic material, a carbon fiber material, a fiber glass material, a glass filled plastic material, a shape-memory metal or alloy, combinations thereof, or any other material that is sufficiently flexible to allow the ends 114a, 114b of the curved band compressible element 112 to be pushed towards one another to reduce the distance therebetween and that has sufficient shape-memory to cause the compressible element 112 to return to its original uncompressed state when the ends 114a, 114b are no longer pushed towards one another. Exemplary plastic materials of which the compressible element 112 can be made include polypropylene (PP), polyoxymethylene (POM), polyamide (PA), polycarbonate (PC), acrylonitrile-butadiene-styrene (ABS), or a combination thereof. In one embodiment, the compressible element 112 can be made of a metal alloy material (e.g., stainless steel) that is over-molded with a plastic material (e.g., ABS). Preferably the material(s) of which the compressible element 112 is made have a wide range of temperature tolerances so that the material(s) do not break down (e.g., become brittle or melt) if the mounting apparatus 102 is left in a vehicle that is parked in a freezing cold environment or a hot desert environment. In accordance with certain embodiments, to minimize the number of parts that are included in the mounting apparatus 102, the curved band compressible element 112 can be a single element.

The curved band (or other shaped) compressible element 112 can be injection molded or compression molded, or manufactured in some other manner. As noted above, the grips 116 can be integrally formed with the compressible element 112, or can be connected to the first and second ends 114a, 114b of the compressible element 112 by the first and second brackets 118a, 118b, regardless of the shape of the compressible element. To minimize a total number or parts, the compressible element 112 is preferably a single continuous element.

As noted above, the grips 116 can be integrally formed with the compressible element 112, or can be connected to the first and second ends 114a, 114b of the compressible element 112 by the first and second brackets 118a, 118b, regardless of the shape of the compressible element. In accordance with certain embodiments, at least the inner surfaces of the grips 116, which surfaces are intended to come in contact with vehicle headrest posts, can include a gripping material so as to help prevent the mounting apparatus 102 from unintentionally sliding down the vehicle headrest posts under the force of gravity. The gripping material can include, but is not limited to, a thermoplastic elastomer (TPE), rubber, silicon, polymeric material or other plastic, metal, alloy, fabric, composite material or other material capable of increasing the adhesion, grip or coefficient of friction between the gripping surfaces of the grips 116 and a circumferential surface of a vehicle headrest post. Where the gripping material is TPE, or some other plastic and/or rubber material, the grips 116 can be manufactured using a dual-injection molding process so at to apply the TPE or other gripping material over an underlying harder plastic. It would also be possible to press mold the compressible element 112 and/or the grips 116 from sheet plastic. If the compressible element 112 and/or the grips 116 are made of metal, a stamping process can be used to punch and shape components from flat metal stock using a stamping machine, and/or a rolling process can be used to shape components using a rolling machine. A gripping surface can also be applied to surfaces of the grips 116 by dipping the grips 116 in a rubberized liquid material.

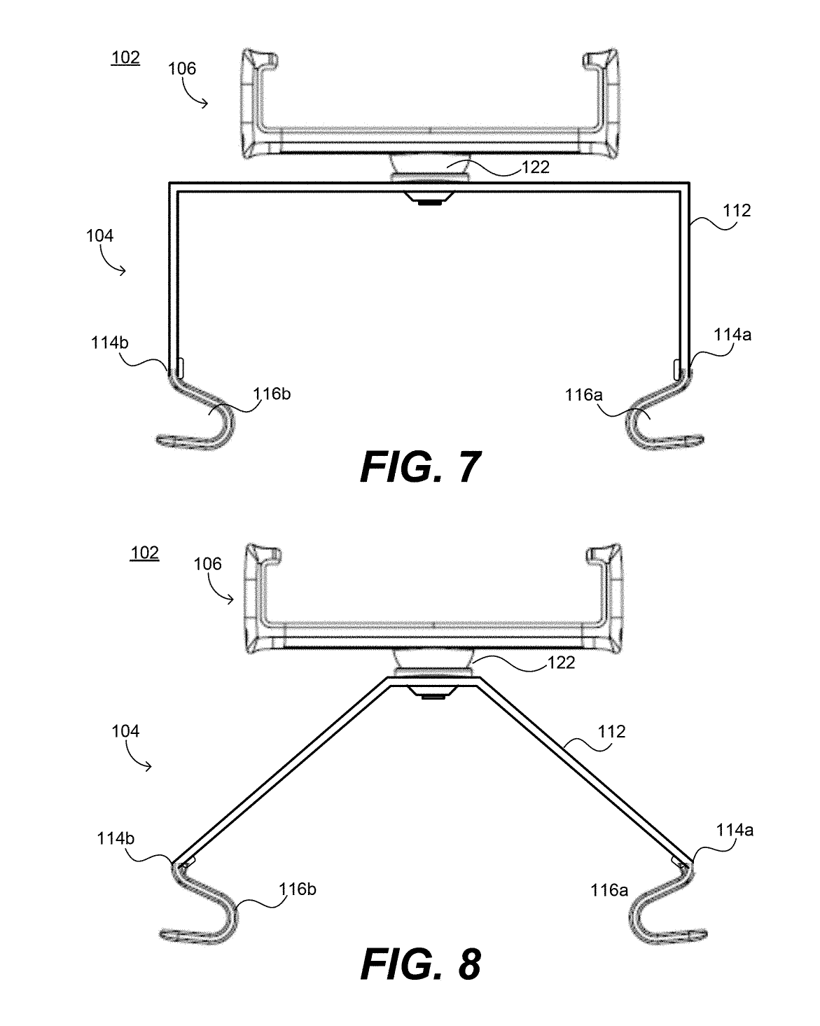

The curved band compressible element 112 can have a semi-elliptical shape or some other partial elliptical shape. Alternatively, the curved band compressible element 112 can have a semi-circular shape or some other partial circular shape. In other words, the curved band can be shaped like a portion of a circumference of a circle or an ellipse. It would also be possible for the compressible element to have a sinusoidal type shape, or a partial sinusoidal shape. Some exemplary further alternative shapes of the compressible element are shown in and described below with reference to FIGS. 7 and 8. Other variations are also possible, and within the scope of the embodiments described herein.

In accordance certain embodiments, the headrest attachment element 104 (and more specifically, the compressible element 112) and the device holder element 106 are attached to one another by a movable joint 122 that enables the device holder element 106 (and thereby, the portable electronic device held therein) to be rotated, panned side-to-side, and/or tilted up-and-down relative to the headrest attachment element 104. The movable joint 122 can be a full ball-and-socket joint that has three degrees of freedom, in that the joint can be rotated about pitch, yaw and roll axis. Alternatively, and more preferably, the movable joint 122 can be a partial ball-and-socket joint, as is the case in the embodiment shown in FIGS. 1-6, which similarly provides three-degrees of freedom, but with a lower profile than a full ball-and-socket joint. Advantageously, the partial ball-and-socket joint also moves the joint's fulcrum closer to a center of mass of a portable electronic device (e.g., 322 in FIG. 3) being held by the device holder element 106. The movable joint 122 can alternatively be a joint having two degrees of freedom, such as, but not limited to, an ellipsoidal joint, a saddle joint, a plane joint or a cylindrical joint. In accordance with an alternative embodiment, the movable joint 122 can instead be a hinged joint (also known as a hinge joint, a pin joint or a revolute joint) or a pivot joint that has one degree of freedom, which depending upon the orientation of the joint, can allow tilting forward and backward, or tilting side to side. The movable joint 122, if it has one or more degree of freedom, is preferably configured to allow the device holder element 106 and the compressible element 112 to rotate relative to one another, e.g., by a full 360 degrees, 180 degrees, or at least 90 degrees. This would allow the mounting apparatus 102 to selectively hold a portable electrical device in a landscape orientation and a portrait orientation, and optionally further orientations therebetween. It would also be possible for the movable joint 122 to have more than three degrees of freedom (e.g., four, five or six degrees of freedom) by providing between one and three degrees of rotational type movement, as well as providing between one and three degrees of translational type movement. For example, the movable joint 122 can include a combination of a gooseneck and a ball-and-socket joint to provide movement with more than three degrees of freedom.

Portions of the movable joint 122 can be integrally formed with the compressible element 112 and/or with a main body 134 of the device holder 106. Alternatively, all elements of the movable joint 122 can be manufactured separately from the compressible element 112 and the main body 134 of the device holder 106, and thereafter one or more portions of the movable joint 122 can be attached to the compressible element 112, and one or more further portions of the movable joint 122 can be attached to the main body 134 of the device holder 106 using one or more fasteners (e.g., screws and/or rivets) and/or a bonding material (e.g., an adhesive). It is also possible that the device holder 106 can be connected to the compressible element 112 by one or more integrated hook structures, portions of which can be integrally formed with or otherwise attached to the compressible element 112 and other portions of which can be integrally formed with or otherwise attached to the device holder 106. Other variations are also possible and within the scope of embodiments described herein.

In one embodiment, the headrest attachment element 104 (and more specifically, the compressible element 112) and the device holder element 106 can be fixedly attached to one another, e.g., by a screw, rivet or other fastener, and/or by a bonding material, thereby eliminating the movable joint 122. This would reduce the manufacturing costs at the expense of reducing the adaptability of the mounting apparatus.

The width (w) of the compressible element 112 can be about 40 mm, and more generally within the range of about 20 mm-80 mm. The thickness (t) can be about 4 mm, and more generally within the range of about 3 mm to 6 mm. The grips 116 can have the same width and thickness as the compressible element 122, or a different width and/or thickness. The use of greater or lesser widths and/or thicknesses than specified above are also possible and with embodiments of the present technology. The optimal width and thickness of the compressible element 112 and/or grips 116 depends on the material(s) used to make these components.

Still referring to FIGS. 1 and 2, the device holder element 106 is shown as including a main body 134 and first and second arms 136a, 136b that extend perpendicularly from the main body 134. An inner surface 138a of the first arm 136a and an inner surface 138b of the second arm 136b oppose one another and are configured to grip or grasp opposing sides of a portable electronic device (e.g., 322 in FIG. 3).

The arms 136a and 136b can include a gripping material on their respective inner surfaces 138a and 138b, in which case the inner surfaces 138a and 138b can be referred to as gripping surfaces. The gripping material can be any material that increases the adhesion, grip or coefficient of friction between the gripping surfaces of the device holder element 106 and a surface of a portal electronic device secured within the device holder element 106. The gripping material can include, but is not limited to, a TPE, rubber, silicon, polymeric material or other plastic, metal, alloy, fabric, composite material or other material capable of increasing the adhesion, grip or coefficient of friction between the gripping surfaces of the device holder element 106 and a surface of a portable electronic device secured therein. It is also possible that a portion of the main body 134 that will come in contact with a portable electronic device includes a gripping surface. In certain embodiments, one or more of the gripping surfaces can be textured. The arms 136a and 136b can be referred to collectively as the arms 136, or individually as an arm 136. Similarly, the surfaces 138a and 138b can be referred to collectively as the surfaces 138, or individually as a surface 138.

A first lip 140a extends perpendicularly from the first arm 138a towards the second arm 138b, and a second lip 140b extends perpendicularly from the second arm 138b towards the first arm 138a. The first and second lips 140a, 140b, which can be referred to collectively as the lips 140, or individually as a lip 140, help secure a portable electronic device (e.g., 322 in FIG. 3) between the arms 138 and against the main body 134, in a similar manner that fingers of a person's hands can help grip an item being held against a person's chest.

In FIGS. 1-6 the device holder element 106 is implemented as an adjustable clamping element that can be expanded and retracted to attach portable electronic devices of different sizes to the mounting apparatus 102. A force can be applied to expand or bias the adjustable clamping element into an activated state (e.g., shown in FIG. 3), and the force can be released to retract the adjustable clamping element into a deactivated state (e.g., shown in FIGS. 1 and 2). An elastic retracting or biasing element (not shown), such as one or more compression or torsion spring(s), can be incorporated into the device holder element 106. The compression or torsion spring(s), and/or one or more other type(s) of spring(s), can facilitate the expansion and retraction of one or both of the arms 136 upon applying or releasing an expansive force. The adjustable clamping element type device holder 106 can also be referred to more succinctly as an adjustable clamp. In accordance with an embodiment, the adjustable clamp or other type of device holder can be configured to secure or hold portable electronic devices having various different sizes, e.g., within a range of 135 mm-235 mm. Alternatively, the device holder can be designed to secure or hold smaller or larger devices by scaling the device holder accordingly.

FIG. 3 is a front perspective view of the mounting apparatus 102 introduced in FIG. 1, mounted to a pair of vehicle headrest posts 306a, 306b (represented in dashed-dotted line) and holding a portable electronic device 322 (represented in dashed line). The vehicle headrest posts 306a, 306b, which can be collectively referred to as posts 306, or individually as a post 306, extend vertically (but potentially at a slight angle) between a headrest 304 and a seatback 312. Such posts 306 typically allow the headrest 304 to be moved up and down relative to the seatback 312 so as to align the height of the headrest with the height of the head of a seated person. In FIG. 3 the grips 116a and 116b are shown as gripping the vehicle headrest posts 306a and 306b, respectively, and thereby attaching the mounting apparatus 102 to the vehicle headrest posts 306.

As also shown in FIG. 3, the device holder element 106 can include a pair of rods 338 that provide a predictable path over which the device holder element 106, implemented as a clamp, can expand and retract. In accordance with an embodiment, a spring (not shown) is inserted over each of the rods 328 and held in place by a screw affixed to ends of the rods 328. These springs can enable one or both of the arms 136 to be expanded and retracted relative to the main body 134. A single rod (e.g., a rectangular or square rod) can be used in place of the pair of cylindrical rods 328 shown in FIG. 3. It is also possible that one or both of the cylindrical rods 328 can be replaced with a rectangular or square rod. In certain embodiments, the device holder element 106 includes a least one rod to provide a predictable path over which the device holder element 106, implemented as a clamp, can expand and retract. In other embodiments, a predictable path over which the device holder element 106, implemented as a clamp, expands and retracts is implemented without any rods. Other variations are possible and within embodiments of the present technology. The arrow 342 in FIG. 3 illustrates the direction of the force that can be used to expand the arm 136b relative to the main body 134.

In FIG. 3 the device holder element 106 is shown as being arranged horizontally and holding a portable electronic device 322 (which has a rectangular shape in this example) in a portrait orientation. In accordance with certain embodiments, the movable hinge 122 enables the device holder element 106 to be rotated by at least 90 degrees, relative to the compressible element 104, so that the device holder element 106 is vertically arranged, and the portable electronic device 322 is in a landscape orientation. In certain embodiments, the moveable hinge 122 allows the device holder element 106 to be rotated by up to 180 degrees relative to the compressible element 104, or by an entire 360 degrees relative to the compressible element 104. The portable electronic device 322 can be a tablet (also known as a tablet computer), an e-book reader, or a smart phone, but is not limited thereto.

FIG. 4 is a top view of the mounting apparatus 102 introduced in FIG. 1, with the grips 116 secured to a pair of vehicle headrest posts 306 shown in dashed-dotted line. Each of the grips 116 includes a first planar portion 402, a second planar portion 406, and a curved portion 404 between and connecting the first and second planar portions 402 and 406. In the embodiment shown in FIG. 4, the first planar portion 402 generally extends from one of the ends 114 of the compressible element 104, in a direction towards the other one of the ends 114 of the compressible element. An angle θ between the first and second planar portions 402 and 406 can be an acute angle. In accordance with an embodiment, the acute angle θ between the first and second planar portions 402 and 406 is 25 degrees, and more generally, can be any angle between −20 degrees and 45 degrees, inclusive. A diameter of the curved portion 404, if the curved portion 404 is extended to form a complete circle, can be within a range of 8 mm-20 mm. The length of each of the first and second planar portions 402 and 406 can be, e.g., in the range of 15 mm-35 mm.

The grips 116 are configured to be able to accommodate (i.e., securely grip themselves to) vehicle headrest posts 306 of various different diameters, so that the mounting apparatus 102 can be used in various different vehicles produced by various different automotive manufacturers. For example, in accordance with an embodiment, where a diameter of the curved portion 404 is 10 mm, the acute angle θ between the first and second planar portions 402 and 406 is 25 degrees, and the length of each of the first and second planar portions 402 and 406 is 20 mm, each grip 116 can accommodate (i.e., securely grip itself to) vehicle headrest posts 306 having a diameter in the range of 10 mm-17 mm. For another example, where a diameter of the curved portion 404 is 8 mm, the acute angle θ between the first and second planar portions 402 and 406 is 45 degrees, and the length of each of the first and second planar portions 402 and 406 is 20 mm, each grip 116 can accommodate (i.e., securely grip itself to) vehicle headrest posts 306 having a diameter in the range of 8 mm-20 mm, which would accommodate most vehicle headrest posts included in most vehicles produced by most automotive manufacturers. The smaller the diameter of the posts 306 the closer the posts 306 would get to the curved portions 404 of the grips 116, potentially resting against the curved portions 404. In an alternative embodiment, the curve portion 404 can be removed, in which case the first and second planar portions 402 and 406 can meet at a sharp angle. It is also possible that inner surfaces of the grips 116 be curved, rather than planar.

Still referring to FIG. 4, the distance (d3) between a pair of vehicle headrest posts, which distance can also be referred to as an inter-post distance or gap, is typically in the range of about 90 mm-160 mm for most vehicles, with 90 mm being the low end of the range, and 160 mm being the high end of the range. Accordingly, the mounting apparatus 102 is preferably configured to be capable of being attached to any pair of vehicle headrest posts having an inter-post gap within the aforementioned range. To provide for a snug grip, the distance (d2) between centers of the first and second grips 116 should be greater than the inter-post gap (d3) of the vehicle headrest posts 306 to which the mounting apparatus 102 is attached, so that the compressible element 112 remains partially compressed while the mounting apparatus 102 is installed. This way, the compressible element 112 provides an outward force against the vehicle headrest posts 306, which helps provide for a snug and secure grip. In FIG. 4, the outwardly directed arrows labeled 412 represent the outward force that the compressible element 112 provides against the vehicle headrest posts 306. Exemplary alternative configurations for the grips 116, which also allow the grips 116 to accommodate (i.e., securely grip themselves to) vehicle headrest posts 306 having a diameter in the range of 8 mm-20 mm are described below with reference to FIGS. 9A, 9B and 9C.

FIG. 5 will now be used to explain how the mounting apparatus 102 can be installed (i.e., mounted) in a vehicle, and more specifically, selectively attached to a pair of spaced apart vehicle headrest posts 306. As noted above, FIG. 5 is a top view of the mounting apparatus 102 introduced in FIG. 1. In FIG. 5, the arrows 502 represent a compressive force (e.g., applied by a person's hand(s)) that moves the first and second ends 114a, 114b of the compressible element 112 towards one another, which has the effect of causing the distance between the first and second ends 114a, 114b of the compressible element 112 to be spaced apart from one another by a distance (d1′) that is less than the distance (d1) between the ends 114 when the compressible element 112 is in its uncompressed state. In FIG. 5, the compressible element 112 represented in solid line corresponds to the compressible element 112 in a partially compressed state, and the compressible element 112 represented in dotted line corresponds to the compressible element 112 in a more compressed state. The compressible element 112 is biased to try to return to its uncompressed state, when the compression force, represented by the arrows 502, is removed or otherwise not applied. However, if the distance (d2) between the centers of the grips is greater than the inter-post gap distance (d3), which is desirable, then the compressible element 112 will remain partially compressed when the mounting apparatus 102 is installed, which will help maintain a snug grip between the grips 116 and the posts 306.

Still referring to FIG. 5, in order to install the mounting apparatus 102, a compression force represented by the arrows 502 is applied to the ends 114 of the compressible element 112 so that the distance (d1′) between the first and second ends 114a and 114b of the compressible element 104 is less than the inter-post distance (d3). This enables the mounting apparatus 102 to be maneuvered, in a direction represented by the arrow 504, such that the first and second grips 116a and 116b are aligning with the spaced apart vehicle headrest posts 306a and 306b. At this point, the compressive force (e.g., applied by a person's hand(s)) is removed to thereby allow the compressible element 112 to become partially uncompressed and the first and second grips 116a and 116b to grip the spaced apart vehicle headrest posts 306a and 306b. Prior to or after this point, a portable electronic device (e.g., 322 in FIG. 3) can be secured to the device holder element 106, at which point the portable electronic device is mounted, by the mounting apparatus 102, within a vehicle for hands-free use (e.g., viewing and/or listening). Once the portable electronic device is mounted, a person need not hold onto the device, or the person has both hands available to interact with the device if they desire.

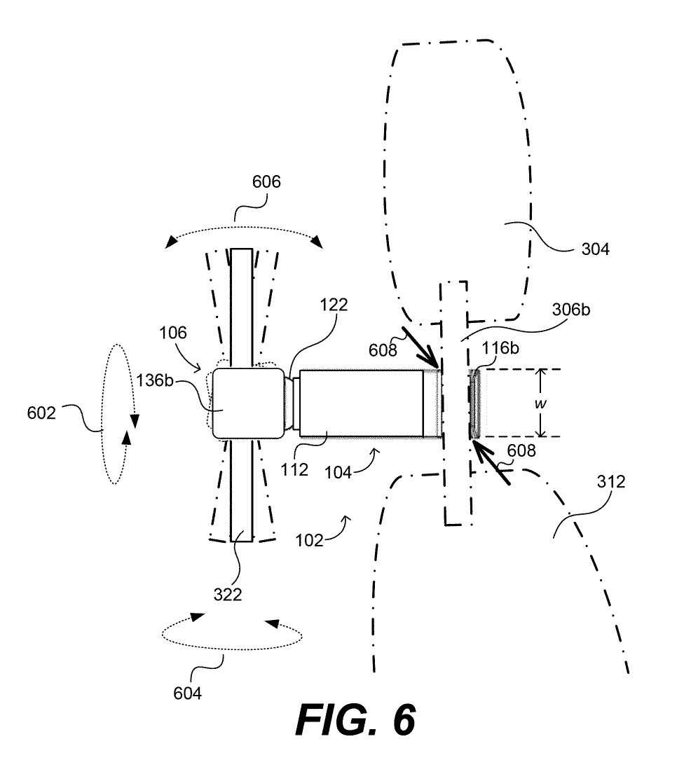

FIG. 6 is a side view of the mounting apparatus 102 introduced in FIG. 1, mounted to a pair of vehicle headrest posts 306 and holding a portable electronic device 322. FIG. 6 is used to show how the movable joint 122 enables the portable electronic device 322 to be maneuvered with various degrees of freedom. More specifically, the arrowed dotted line 602 illustrates that the movable joint 122 enables the device holder 102 (and the portable electronic device 322 held therein) to be rotated. The arrowed dotted line 604 illustrates that the movable joint 122 enables the device holder 102 (and the portable electronic device 322 held therein) to be panned side-to-side. The arrowed dotted line 606 illustrates that the movable joint 122 enables the device holder 102 (and the portable electronic device 322 held therein) to be tilted up-and-down.

FIG. 6 is also used to describe how the width (w) of the grips 116 cause each of the grips to apply moments of force (i.e., torque forces) against regions of the outer circumferences of the vehicle headrest posts 306. The width (w) of each of the grips 116 can be about 40 mm, and can more generally within the range of about 20 mm-80 mm. Because a substantial portion of the mounting apparatus 102 extends horizontally relative to the grips 116, the weight of the device holder element 106 (and a portable electronic device 322 held thereby) will tend to cause the mounting apparatus 102 to try to rotate downward. However, because of the width (w) of the grips, the aforementioned rotation is prevented or at least significantly reduced. Beneficially, these torque forces cause inner opposing surfaces (e.g., 402 and 406) of each grip 116 to apply pressure against regions of the outer circumference of the vehicle headrest posts 306 that are about 180 degrees apart from one another, wherein such regions are pointed to by the arrows 608 in FIG. 6. Where the grips 116 are tapered, e.g., as described above with reference to FIG. 4, the grips 116 also apply compressive wedge forces against the vehicle headrest posts 306.

As noted above, in alternative embodiments the compressible element of the headrest attachment element 104 can have alternative shapes than shown in FIGS. 1-5. For example, FIG. 7 shows a mounting apparatus 102 wherein the compressible element 112 has a squared U-shape, and in FIG. 8 shows a mounting apparatus 102 wherein the compressible element 112 has a V-shape. Other variations are also possible and within the scope of embodiments of the present technology. For example, as noted above, the compressible element can have a sinusoidal shape or a partial sinusoidal shape. It would also be possible for the compressible element of the headrest attachment element 104 to have a combination of two or more of the aforementioned shapes.

In the embodiments described above with reference to FIGS. 1-8, the device holder 106 was shown and described as being an adjustable clamping element type device holder. That is the preferred embodiment, because an adjustable clamp should hold the portable electronic device securely and should accommodate a wide range of sizes of portable electronic devices. However, in accordance with alternative embodiments, the device holder 106 can have alternative configurations. For example, the device holder 106 can resemble a painting easel that includes a ledge, and may include one or more bungee type cords to strap a portable electronic device to the easel like device holder. In another embodiment, the device holder 106 can include a pocket or slot into which a portable electronic device can slide into either vertically downward or upward, or horizontally sideways. Additionally, or alternatively, the device holder can include and utilize one or more magnets, one or more suction cups, a gecko like adhesive (e.g., Geckskin™), one or more polyurethane (PU) gel pads and/or a hook-and-loop fastener (e.g., Velcro™) to help hold a portable electronic device to the mounting apparatus. Other variations are also possible and within embodiments of the present technology.

In FIGS. 1-8, each of the grips 116 was shown as having a tapered mouth, wherein a distance between opposing surfaces 402 and 406 of each grip 116 tapers down (i.e., decreases) from the open end of the grip 116 toward the curved closed end (labeled 404 in FIG. 4). This configuration of the grips was primarily explained with reference to FIG. 4. FIGS. 9A, 9B and 9C show alternative configurations for the grips 116. In FIG. 9A, opposing surfaces 402 and 406 of each of the grips 116 are parallel or at least substantially parallel to one another, and thus, a distance between opposing surfaces 402 and 406 of each of the grips remains constant from the open end of the grip 116 toward the curved closed end. In FIG. 9B, a distance between opposing surfaces 402 and 406 of each of the grips 116 tapers up (i.e., increases) from the open end of the grip 116 toward a center of the grip 116, and then tapers down (i.e., decreases) from the center of the grip 116 toward the curved closed end. In FIG. 9C, a distance between opposing surfaces 402 and 406 of each of the grips 116 tapers up (i.e., increases) from the open end of the grip 116 towards the curved closed end. Other variations are also possible and within embodiments of the present technology. In FIGS. 9A, 9B and 9C the device holder 106 is not shown. However, it should be understood that the device holder 106, or an alternative device holder (examples of which were described above), should be attached to each of the compressible elements 112 shown in FIGS. 9A, 9B and 9C, e.g., by a movable hinge (e.g., 122).

In FIGS. 1-8, 9A, 9B and 9C, the distance (d2) between the centers of the first and second grips 116a and 116b was less than the distance (d1) between the first and second ends 114a and 114b of the compressible element 112. FIG. 10 shows an alternative embodiment where a distance (d2) between centers of the first and second grips 116a and 116b is greater than the distance (d1) between the first and second ends 114a and 114b of the compressible element 112. In FIG. 10 the device holder 106 is not shown. However, it should be understood that the device holder 106, or an alternative device holder (examples of which were described above), should be attached to the compressible elements 112 shown in FIG. 10, e.g., by a movable hinge (e.g., 122).

Referring now to FIGS. 11A and 11B, in accordance with certain embodiments there is a respective flexible joint 1114a, 1114b (e.g., a living hinge type flexible joint) at each of the first and second ends 114a, 114b from which the first and second grip 116a, 116b extend. In other words, the flexible joint 1114a connects the grip 116a to the first end 114a of the compressible element 112, and the flexible joint 1114b connects the grip 116b to the second end 114b of the compressible element 112. The flexible joints 1114a, 1114b can be referred to collectively as the flexible joints 1114, or individually as a flexible joint 1114. The flexible joints 1114 are configured to cause the grips 116 to rotate and counteract external forces that may be applied to the headrest attachment element 104 to thereby prevent dislodgement or ejection of the headrest attachment element 104 (and thus, the mounting apparatus 102 and the portable electronic device 322 attached thereto) from the vehicle headrest posts 306. A pull type external force, represented by arrows 1106 in FIG. 11A, may be applied to the headrest attachment element 104, e.g., if a person pulls on the portable electronic device 322 that is being held by the mounting apparatus 102. A push type external force, represented by arrows 1108 in FIG. 11B, may be applied to the headrest attachment element 104, e.g., if a person pushes on the portable electronic device 322 that is being held by the mounting apparatus 102.

Referring to FIG. 11A, the flexible joint 1114a (e.g., a living hinge type flexible joint) is located at the first end 114a of the compressible element 112 at a location from which the first grip 116a extends. Similarly, the flexible joint 1114b (e.g., a living hinge type flexible joint) is located at the second end 114b of the compressible element 112 at a location from which the second grip 116b extends. The dashed line in FIG. 11A is illustrative of the headrest attachment element 104, including the compressible element 112 and the grips 116, when no external force is applied. The solid line in FIG. 11A is illustrative of the headrest attachment element 104 when a pull force, represented by the arrows 1106, is applied. The curved arrows labelled 1110a and 1110b show that the flexible joints 1114a and 1114b cause the grips 116a and 116b to respectively rotate counter-clockwise and clockwise in response to the pull force represented by arrows 1106.

In FIG. 11B, the dashed line is illustrative of the headrest attachment element 104, including the compressible element 112 and the grips 116, when no external force is applied. The solid line in FIG. 11B is illustrative of the headrest attachment element 104 when a push force, represented by the arrows 1108, is applied. The curved arrows 1111a and 1111b show that the flexible joints 1114a and 1114b cause the grips 116a and 116b to respectively rotate clockwise and counter-clockwise in response to the push force represented by the arrows 1108.

The device holder 106 is not shown in FIGS. 11A and 11B. However, it should be understood that the device holder 106, or an alternative device holder (examples of which were described above), should be attached to the compressible element 112 shown in FIGS. 11A and 11B, e.g., by a movable hinge (e.g., 122).

In the embodiments described above, e.g., with reference to FIGS. 1-8, 9A, 9B, 9C, 10, 11A and 11B, the headrest attachment element 104 was shown and describes as including a compressible element (e.g., 112) and the grips (e.g., 116) of the headrest attachment element 104 were configured such that first and second ends (e.g., 114a and 114b) of the compressible element (e.g., 112) were intended to be moved towards one another by application of an external compressive force (e.g., represented by the arrows 402 in FIG. 5) to cause the distance between the first and second ends (e.g., 114a and 114b) of the compressible element (e.g., 112) to be decreased to enable the headrest attachment element 104 to be attached to a pair of spaced aparat vehicle headrest posts (e.g., 306). Additionally, in the embodiments described above, after the compressive force (e.g., represented by the arrows 502 in FIG. 5) was removed, the shape-memory of the compressible element (e.g., 112) caused the compressible element to try to return to its uncompressed state. So long as the distance between the centers of the grips was greater than the inter-post gap distance, then the compressible element 112 remained partially compressed, causing the grips 116 to apply an outward force against the vehicle headrest posts 306 that help maintain a snug grip.

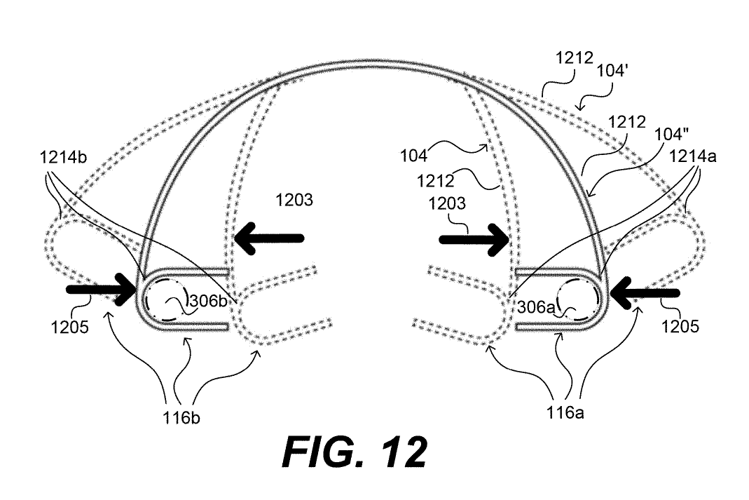

In alternative embodiments described below, an example of which is shown in FIG. 12, a headrest attachment element 104 of a mounting apparatus 102 includes an expandable element 1212 (instead of a compressible element 112) and the grips 116 are configured such that first and second ends 1214a and 1214b of the expandable element 1212 are intended to be moved away from one another by application of an external expansion force (e.g., represented by the arrows 1203 in FIG. 12) to cause the distance between the first and second ends (e.g., 1214a and 1214b) of the expandable element 1212 to be increased to enable the headrest attachment element 104 to be attached to a pair of vehicle headrest posts (e.g., 306). In such embodiments, after the expansion force (e.g., represented by the arrows 1203 in FIG. 12) is removed, the shape-memory of the expandable element 1212 causes the expandable element 1212 to try to return (and more specifically compress) to its unexpanded state. However, so long as the distance between the vehicle headrest posts is greater than the distance between the grips 116 (when the expandable element 1212 is in its fully unexpanded), then the expandable element 1212 remains partially expanded, causing the grips 116 to apply an inward force against the vehicle headrest posts 306 that help maintain a snug grip.

A comparison between FIG. 12 and earlier described FIGS. shows that the openings or mouths of the grips 116 in FIG. 12 face inward toward one another, wherein in the earlier described FIGS. the openings or mouths of the grips 116 faced outward away from one another. The grips 116 can different shapes than those shown in FIG. 12, examples of which were shown in and described above with reference to FIGS. 9A, 9B and 9C. Further, it is noted that the grips 116 can be connected to the expandable element 1212 by flexible joints (e.g., living hinges), in a similar manner as was described above with reference to FIGS. 11A and 11 B. The expandable element 1212 can be made of a flexible material having shape memory, examples of which were provided above when describing the compressible element 112. In FIG. 12 the expandable element 1212 is a curved band having a partial elliptical shape. In alternative embodiments, expandable element 1212 can have other shapes, such as, but not limited to, a U-shape, a C-shape, a V-shape, a sinusoidal shape, a partial sinusoidal shape or a partial circular shape.

In FIG. 12, the dashed line labeled 104 corresponds to the headrest attachment element when the expandable element 1212 in its relaxed unexpanded state. The dashed line labeled 104′ corresponds to the headrest attachment element when the expandable element 1212 is sufficiently expanded to enable the grips 1216 to be aligned with and slipped over a pair of spaced apart vehicle headrest posts 306. The solid line labeled 104″ corresponds to the headrest attachment element 104 after it is attached to the pair of spaced apart vehicle headrest posts 306 and the expandable element 1212 is in a partially expanded state, which causes the grips 116 to apply an inward force (represented by the arrows 1205) against the vehicle headrest posts 306 that help maintain a snug grip. The device holder 106 is not shown in FIG. 12. However, it should be understood that the device holder 106, or an alternative device holder (examples of which were described above), should be attached to the expandable element 1212 shown in FIGS. 12, e.g., by a movable hinge (e.g., 122).

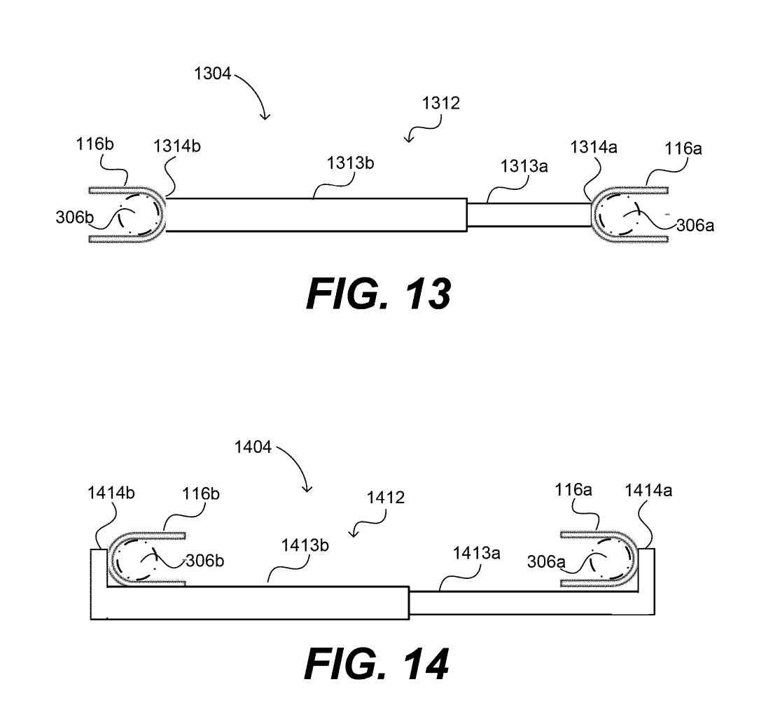

In the above described embodiments, the compressible element 112 and the expandable element 1212 were shown as and described as being made from a material having shape-memory that was relied upon to cause the grips 116 to provide an inward or outward force against the vehicle headrest posts that help maintain a snug grip. In alternative embodiments, described below with reference to FIGS. 13 and 14, rather than relying upon a material having shape-memory, the headrest attachment element utilizes a linear spring loaded expansive or compressive force to cause the grips of the headrest attachment element to provide an inward or outward force against the vehicle headrest posts that help maintain a snug grip.

Referring to FIG. 13, a headrest attachment element 1304 is shown as including a compressible element 1312 having first and second ends 1314a and 1314b, which are spaced apart from one another, and from which grips 116a, 116b extend. In this embodiment, the compressible element 1312 is linearly compressible and includes a first body portion 1313a and a second body portion 1313b that move linearly relative to one another. When the compressible element 1312 is in its uncompressed state, the first and second ends 1314a and 1314b are spaced apart from one another by a first distance. The first and second ends 1314a and 1314b of the compressible element 1312 are movable towards one another by application of an external compressive force that causes the first and second ends 1314a and 1314b of the compressible element 1312 to be spaced apart from one another by less than the first distance. One or more springs (not shown in FIG. 13) bias the compressible element 1312 to return to its uncompressed state when not being compressed, in a similar manner that a spring loaded tension shower rod functions.

The headrest attachment element 1304 shown in FIG. 13 is configured to be selectively attached to a pair of spaced apart vehicle headrest posts 306, without removing a vehicle headrest from a seatback to which the vehicle headrest is attached by the posts. This is achieved by applying a compressive force to the compressible element 1312 until the first and second ends 1314a and 1314b of the compressible element 1312 are spaced apart from one another by a distance that is less than an inter-post distance between the spaced apart vehicle headrest posts 306 to which the headrest attachment element 1304 is to be attached, and then inserting the first and second ends 1314a and 1314b of the compressible element 1312 between the spaced apart vehicle headrest posts 306, aligning the first and second grips 116a and 116b with the spaced apart posts of the vehicle headrest, and removing the compressive force to thereby allow the compressible element 1312 to become at least partially uncompressed and the first and second grips 116a and 116b to grip the spaced apart vehicle headrest posts 306. The compressible element 1312 will remain partially compressed if the spaced apart vehicle headrest posts (e.g., 306) prevent the compressible element 1312 from completely returning to its uncompressed state. This way, the compressible element 1312 provides an outward force against the vehicle headrest posts 306, which helps provide for a snug and secure grip. The device holder 106 is not shown in FIG. 13. However, it should be understood that the device holder 106, or an alternative device holder (examples of which were described above), should be attached to the compressible element 1312 shown in FIGS. 13, e.g., by a movable hinge (e.g., 122).

Referring now to FIG. 14, a headrest attachment element 1404 is shown as including an expandable element 1412 having first and second ends 1414a and 1414b, which are spaced apart from one another, and from which grips 116a, 116b extend. In this embodiment, the expandable element 1412 is linearly expandable and includes a first body portion 1413a and a second body portion 1413b that move linearly relative to one another. When the expandable element 1412 is in its relaxed unexpanded state, the first and second ends 1414a and 1414b are spaced apart from one another by a first distance. The first and second ends 1414a and 1414b of the expandable element 1412 are movable away from one another by application of an external expansive force that causes the first and second ends 1414a and 1414b of the expandable element 1412 to be spaced apart from one another by more than the first distance. One or more springs (not shown in FIG. 14) bias the expandable element 1412 to return to its unexpanded state when not being expanded, e.g., in a similar manner as the clamping type device holder described above. The aforementioned expansive force can also be referred to as an expansion force.

The headrest attachment element 1404 shown in FIG. 14 is configured to be selectively attached to a pair of spaced apart vehicle headrest posts 306, without removing a vehicle headrest from a seatback to which the vehicle headrest is attached by the posts. This is achieved by applying an expansive force to the expandable element 1412 until the first and second ends 1414a and 1414b of the expandable element 1412 are spaced apart from one another by a distance that is greater than an inter-post distance between the spaced apart vehicle headrest posts 306 to which the headrest attachment element 1404 is to be attached, and then inserting the first and second ends 1414a and 1414b of the expandable element 1412 between the spaced apart vehicle headrest posts 306, aligning the first and second grips 116a and 116b with the spaced apart posts of the vehicle headrest, and removing the expansive force to thereby allow the expandable element 1412 to become at least partially unexpanded and the first and second grips 116a and 116b to grip the spaced apart vehicle headrest posts 306. The expandable element 1412 will remain partially expanded if the spaced apart vehicle headrest posts (e.g., 306) prevent the expandable element 1412 from completely returning to its unexpanded state. This way, the expandable element 1412 provides an inward force against the vehicle headrest posts 306, which helps provide for a snug and secure grip. The device holder 106 is not shown in FIG. 14. However, it should be understood that the device holder 106, or an alternative device holder (examples of which were described above), should be attached to the expandable element 1412 shown in FIGS. 14, e.g., by a movable hinge (e.g., 122).

In the embodiments described above, the grips 116 relied on biasing of the compressible or expandable element and optionally a gripping surface to provide for a snug engagement with vehicle headrest posts. Additionally, in the embodiments described above, the mouth or opening of each of the grips 116 always remained opened and the grips did not include any movable parts. These are the preferred embodiments, because they provide for a very simple and elegant way of attaching and detaching the mounting apparatus 102 to/from vehicle headrest posts, and provide for relatively simple and inexpensive manufacturing of the mounting apparatus 102 by minimizing the number of movable parts and total parts. However, in accordance with alternative embodiments, each of the grips may include a movable clasp, clip or other locking mechanism that may increase how snugly the grips are secured to vehicle headrest posts.

Embodiments of the present technology also cover any and all combinations of the embodiments described above with reference to the various FIGS. For example, the various different shapes for the grips 116 described with reference to FIGS. 9A, 9B and 9C can be combined with any of the other embodiments described above, such as those described with reference to FIGS. 13 and 14. For another example, the gripping materials described above can be used in any of the embodiments. For still another example, the various different types of movable joints described above can be used in any of the embodiments.

Embodiments of the present technology described herein overcome many of the drawbacks associated with previously available apparatuses for mounting portable electronic devices in vehicles. For example, embodiments of the present technology do not (or minimally) interfere with the operation of a vehicle headrest. Further, embodiments of the present technology can be designed and manufactured to have an attractive and minimalist appearance. Additionally, embodiments of the present technology are useful with headrests having a wide range of inter-post distances between pairs of vehicle headrest posts. Further, embodiments of the present technology accommodate a range of distances between vehicle headrest posts in a simple and uncumbersome manner. Advantageously, the mounting apparatuses of various embodiments of the present technology are configured to be attached and detached from vehicle headrest posts without requiring that a headrest to be temporarily removed from a seatback. Further, the mounting apparatuses of various embodiments of the present technology can hold portable electronic devices of any one of a plurality of different sizes. This is a list of just some benefits associated with the embodiments of the present technology, which is not intended to be all inclusive list.

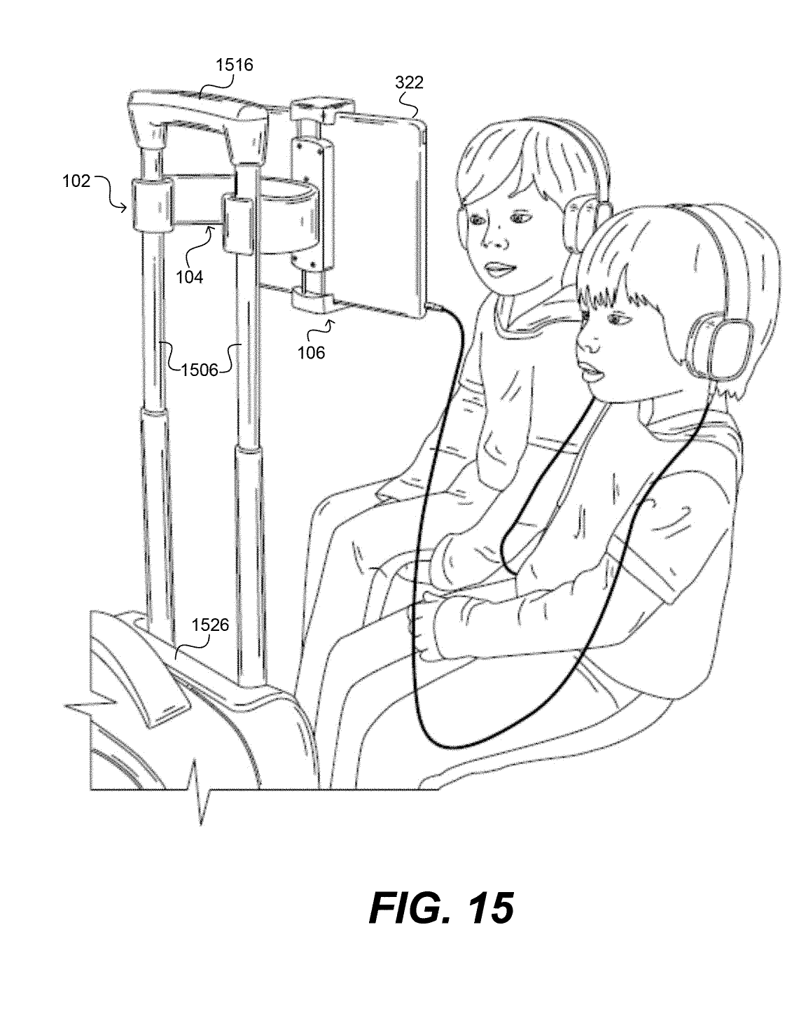

FIG. 15 illustrates how the apparatuses described herein can be used to attach a portable electronic device to a pair of posts of a telescopic handle of a rolling suitcase, instead of to vehicle headrest posts. More specifically, referring to FIG. 15, the mounting apparatus 102 introduced above with reference to FIGS. 1-6 is shown as being attached to posts 1506 of a telescopic handle 1516 of a suitcase 1526. However, it should be appreciated that the other mounting apparatuses described above with reference to the other FIGS. (e.g., FIGS. 7-14) can similarly be used to mount a portable electronic device (e.g., 322) to posts 1506 of a telescopic handle 1516 of a rolling suitcase 1526. More generally, the embodiments described herein can be used to attach a portable electronic device to various different types of pairs of posts, e.g., where the inter-post distance between the pair of posts is within a range of 90 mm-160 mm. Other inter-post distances can be accommodated by changing (e.g., scaling up or scaling down) the size of the element (e.g., 104, 1304 or 1404) that attaches to a pair of posts.

Referring back to FIG. 3, in FIG. 3 the device holder 106 is shows as being lined up with the element 104 (previously referred to as the headrest attachment element). By contrast, in FIG. 15 the device holder 106 is rotated by 90 degrees so that the device holder 106 is arranged perpendicular to the element 104 (previously referred to as the headrest attachment element).

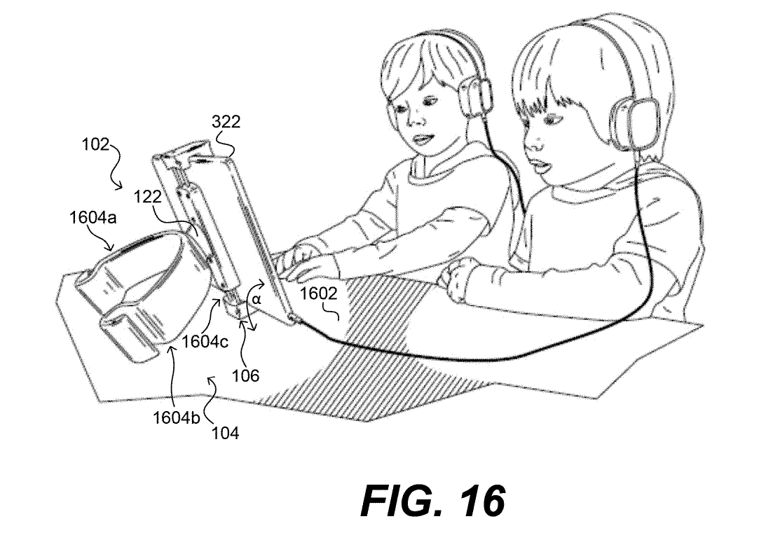

FIG. 16 illustrates how apparatuses described herein can also be used as a stand for supporting a portable electronic device at an angle on a flat surface, such as a tabletop. More specifically, referring to FIG. 16, the device holder 106 of the mounting apparatus 102, introduced above with reference to FIGS. 1-6, is shown holding a portable electronic device (e.g., 322). As shown in FIG. 16, the device holder 106 and the element 104 (previously referred to as the headrest attachment element) collectively provide a stand to support a portable electronic device 322 at an acute angle a relative to a horizontal tabletop 1602 on which the apparatus 102 is resting. As explained above, in certain embodiments the device holder 106 is attached to the element 104 by a movable joint 122. In accordance with certain embodiments, the movable joint 122 allows the device holder 106 to be rotated by 90 degrees so that the device holder 106 can be arranged perpendicular to the element 104, as was shown in FIG. 15 and as also shown in FIG. 16.

As can be appreciated from FIG. 16, when the device holder 106 is arranged perpendicular to the element 104, the apparatus 102 (and the other apparatuses described herein) is useful as a stand that supports a portable electronic device, being held by the device holder 106, at an acute angle relative to a horizontal surface (e.g., a tabletop 1610) upon which the apparatus 102 is resting. The movable joint 122 can be used to arrange the device holder 106 perpendicular relative to the element 104. Alternatively, the device holder 106 can be fixedly attached perpendicular relative to the element 104. Either way, the apparatus 102 (or the other apparatuses described herein) can be used as a stand.

Still referring to FIG. 16, when the apparatus 102 (or another apparatus described herein) is used as a stand that supports a portable electronic device 322, the stand includes three support legs. A first half of the element 104 provides a first support leg 1604a, and a second half of the element 104 provides a second support leg 1604b. Half of the device holder 106 provides a third support leg 1604c. When the apparatus 102 (or another apparatus described herein) is used as a stand, a portion of each of the three support legs 1604a, 1604b and 1604c rests on a horizontal surface, such that the apparatus 102 functions like a tripod.

The apparatus 102 (or another apparatus described herein) can also be used as a stand when the device holder 106 and the element 104 (previously referred to as the headrest attachment element) are lined up with (and thereby parallel to) one another, e.g., as arranged in FIG. 3. In such an arrangement, first and second halves of the element 104 would provide first and second support legs for resting on a horizontal surface (e.g., a tabletop), and a peripheral edge of a portable electronic device (held within the device holder element 106) would provide a third support for resting on the horizontal surface. This alternative stand arrangement can be appreciated from FIG. 16. Referring to FIG. 16, the alternative stand arrangement could be achieved by keeping element 104 as shown, but rotating the element 106 (and the portable electronic device 322 held therein) by ninety degrees relative to the element 104, such that the element 104 and 106 are parallel or lined up to one another. In such an arrangement, one of the peripheral edges of the portable electronic device 322 would rest on the tabletop 1602.

FIGS. 15 and 16 are used to illustrate that the apparatuses (e.g., 102) described herein can be used in various different manners, and thus, can be useful even outside of vehicles.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus useful for mounting a portable electronic device to a pair of spaced apart posts, the apparatus comprising:
a first element including a portion that is compressible or expandable, the first element configured to be selectively attached to a pair of spaced apart posts by application of an external compressive or expansive force to the portion that is compressible or expandable to thereby decrease or increase a distance between distal ends of the first element until grips of the first element can be aligned with and attached to the spaced apart posts, and then removing the external compressive or expansive force; and
a second element attached to the first element, the second element configured to selectively hold a portable electronic device;
wherein the portion of the first element that is compressible or expandable is configured to remain partially compressed or partially expanded while the first element is attached by the grips to a pair of spaced apart posts.

2. The apparatus of claim 1, wherein the first and second elements are attached to one another by a movable joint that enables the first and second elements to be rotated relative to one another.

3. The apparatus of claim 2, wherein:
when one of the first and second elements is rotated relative to the other such that the first and second elements are perpendicular to one another, the apparatus is useful as a stand including three support legs that support a portable electronic device, being held by the second element, at an acute angle relative to a horizontal surface upon which the apparatus is resting; and
the three support legs include
a first support leg comprising a first half of the first element,
a second support leg comprising a second half of the first element, and
a third support leg comprising a half of the second element.

4. The apparatus of claim 3, wherein when one of the first and second elements is rotated relative to the other such that the first and second elements are perpendicular to one another and the apparatus is used as a stand, a portion of each of the three support legs can be rested on a horizontal surface, so that the apparatus functions like a tripod.

5. The apparatus of claim 1, wherein when the first and second elements are arranged such that they are in line with one another, the apparatus is useful as a stand that supports a portable electronic device, being held by the second element, at an acute angle relative to a horizontal surface upon which the apparatus is resting

6. The apparatus of claim 5, wherein when the first and second elements are arranged such that they are in line with one another and the apparatus is used as a stand, first and second halves of the first element provide first and second support legs for resting on a horizontal surface, and a peripheral edge of a portable electronic device held within second element provides a third support for resting on a horizontal surface.

7. The apparatus of claim 1, wherein the first element is configured to be attachable to a pair of spaced apart posts having any one of a plurality of different inter-post distances within a range of 90 mm-160 mm.

8. The apparatus of claim 1, wherein the grips of the first element are configured to be attachable to posts having any one of a plurality of different diameters within a range of 8 mm-20 mm.

9. The apparatus of claim 1, wherein the portion of the first element that is compressible or expandable is made of a plastic material, a carbon fiber material, a fiber glass material, a glass filled plastic material, a metal or alloy, or a combination thereof.

10. The apparatus of claim 1, wherein the portion of the first element that is compressible or expandable has shape-memory and is configured to return to its uncompressed or unexpanded shape after an external compressive or expansive force is completely removed.

11. The apparatus of claim 10, wherein the portion of the first element that is compressible or expandable is configured to remain partially compressed or partially expanded while the first element is attached to a pair of spaced apart posts due to the posts preventing the portion of the first element that is compressible or expandable from completely returning to its uncompressed or unexpanded state.

12. The apparatus of claim 1, wherein the second element comprises an adjustable clamp that is configured to selectively hold a portable electronic device having any one of a plurality of different sizes.

13. An apparatus that can be used for mounting a portable electronic device to a pair of spaced apart posts, and that also can be used as a stand to support a portable electronic device at an angle relative to a horizontal support surface on which the apparatus is resting, the apparatus comprising:
a first element configured to be selectively attached to a pair of spaced apart posts by application of an external compressive or expansive force to thereby decrease or increase a distance between portions of the first element until grips of the first element can be aligned with and attached to the spaced apart posts, and then removing the external compressive or expansive force; and
a second element attached to the first element, the second element configured to selectively hold a portable electronic device;
wherein the first and second elements of the apparatus collectively provide a stand that can support a portable electronic device, being held by the second element, at an acute angle relative to a horizontal surface upon which the apparatus is resting.

14. The apparatus of claim 13, wherein when the apparatus is used as a stand the apparatus functions like a tripod.

15. The apparatus of claim 13, wherein the second element comprises an adjustable clamp that is configured to selectively hold a portable electronic device having any one of a plurality of different sizes.

16. The apparatus of claim 13, wherein the portion of the first element that is compressible or expandable is configured to remain partially compressed or partially expanded while the first element is attached by the grips to a pair of spaced apart posts.

17. An apparatus comprising:
an element that is compressible or expandable and has first and second ends that are spaced apart from one another by a first distance when the element is in its uncompressed or unexpanded state, wherein the first and second ends of the element are movable towards or away from one another by application of an external force that causes the first and second ends of the element to be spaced apart from one another by less than or more than the first distance, and wherein the element is biased to try to return to its uncompressed or unexpanded state when the external force is not being applied;
first and second grips extending, respectively, from the first and second ends of the element, wherein the first and second grips are configured to grip a pair of spaced apart posts; and
an adjustable clamp attached to a portion of the element between the first and second ends, the adjustable clamp configured to selectively hold a portable electronic device having any one of a plurality of different sizes;
wherein the apparatus can be used for mounting a portable electronic device to a pair of spaced apart posts; and
wherein the apparatus can also be used as a stand to support a portable electronic device at an angle relative to a horizontal support surface on which the apparatus is resting.

18. The apparatus of claim 17, wherein the element that is compressible or expandable is made of a flexible material having shape-memory and has a shape selected from the group consisting of:
a U-shape;
a C-shape;
a V-shape;
a sinusoidal shape;
a partial sinusoidal shape;
a partial circular shape; or
a partial elliptical shape.

19. The apparatus of claim 17, wherein when the apparatus is used as a stand the apparatus functions like a tripod.

20. The apparatus of claim 17, wherein the adjustable clamp is attached to the element that is compressible or expandable by a movable joint.
